(19) United States
(12) Patent Application Publication
(10) Pub. No.: US 2006/0180583 A1
(43) Pub. Date: Aug. 17, 2006

(54) Glasses temperature regulation device

(75) Inventor: Tom Jones, Windsor (CA)

Correspondence Address: DOBRUSIN & THENNISCH PC, 29 W LAWRENCE ST, SUITE 210, PONTIAC, MI, 48326, US

(73) Assignee: W.E.T. Automotive Group AG

(21) Appl. No.: 11/346,969

(22) Filed: Feb. 3, 2006

Related U.S. Application Data
(60) Provisional application No. 60/649,783, filed on Feb. 3, 2005.

(51) Int. Cl. B60L 1/02; F24C 7/10

(52) U.S. Cl. 219/202; 219/386

(57) ABSTRACT

The present invention includes a temperature controller for regulating the temperature of glasses in a vehicle. A solid state temperature regulation device, with at least a pair of electrical contacts, is used to heat or cool the glasses in the vehicle. An attachment device holds hold the glasses near the temperature regulation device promote energy transfer to the glasses. An electrical plug connects the regulation device to a power source through the electrical contacts, while a control device regulates the temperature of the glasses.

### FIELD OF THE INVENTION

The present invention relates to solid state temperature regulation devices for use in transportation vehicles, and more particularly, devices which may be used to regulate the temperature of eyeglasses that are stored in automobiles.

### BACKGROUND OF THE INVENTION

Storing glasses (e.g. sunglasses or eyeglasses) in an automobile means that the glasses take on the ambient temperature of the vehicle. When parked in colder climates, for example overnight, glasses may become quite cold to the touch. Not only are they initially uncomfortable to wear, but the lens may also fog due to the temperature difference between the wearer and the glasses.

In hot climates, glasses stored in the vehicle may become uncomfortable hot, especially during the day when temperatures inside a vehicle may easily reach 120° F.

Known solutions to these problems include blowing warm or cool air from the vehicle's HVAC system onto the glasses. However, these solutions require complex and costly routing of air ducts through the passenger compartment. This is especially true for glasses compartments that are located in an overhead console of the vehicle.

The present invention overcomes these problems by cost-effectively regulating the microclimate of the glasses to prevent the glasses from becoming comfortably hot or cold, while also effectively reducing the fogging of glasses.

### SUMMARY OF THE INVENTION

The present invention includes a temperature controller for regulating the temperature of glasses in a vehicle. A solid state temperature regulation device, with at least a pair of electrical contacts, is used to heat or cool the glasses in the vehicle. An attachment device holds the glasses near the temperature regulation device promoting energy transfer to the glasses. An electrical plug connects the regulation device to a power source through the electrical contacts, while a control device regulates the temperature of the glasses.

### BRIEF DESCRIPTION OF THE DRAWINGS

In the drawings:

FIG. 1 depicts an overhead console having a glasses compartment with a temperature regulation device.

FIG. 2 depicts a resistance wire heater temperature regulation device.

### DETAILED DESCRIPTION

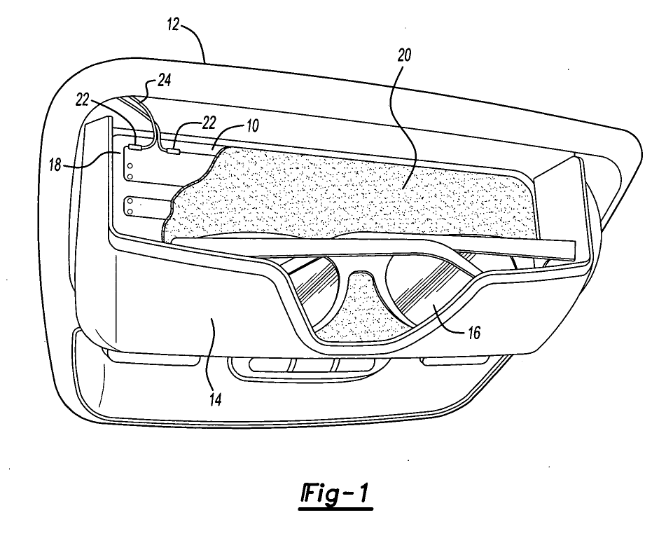

As seen in FIG. 1, a glasses temperature controller 10 may be located in or around the passenger compartment of a vehicle, such as in an overhead console 12. The temperature controller comprises an attachment device 14 to hold a pair of glasses 16 near a temperature regulation device 18. In this embodiment, the temperature regulation device is separated from the glasses by an A-surface material 20. A pair of contacts 22 connects the temperature regulation device to a wiring harness 24. Hidden from the view of the occupant in this embodiment, and not shown in the figure, the temperature controller also comprises an electrical plug which connects the temperature regulation device to a power source. A control device regulates the operation of the temperature regulation device.

The attachment device is any convenient mechanism to hold the glasses in proximity to the temperature regulation device. The attachment device may be a cup, as seen in FIG. 1, a clip, clamp or other device the holds on to the glasses (e.g. at the nose bridge or at the side frames), or a sleeve that the glasses slide into, or the like. Preferably, the attachment device holds the lens of the glasses in closest proximity to the temperature regulation device.

The temperature regulation device includes solid state devices that do not require the use of ducting to transport temperature regulated air to the glasses. By not using temperature conditioned air to accomplish the heating and cooling of the glasses, complexity and cost can be eliminated from systems. Exemplary temperature regulation devices include heaters and thermoelectric devices (TED).

The temperature regulation device is sized and shaped to match its placement within the passenger vehicle, but typically will have a large ratio of area to thickness, such as a film, a sheet, a panel or the like. Preferably, the temperature regulation device does not require that existing dedicated glasses holder be redesigned or enlarged, as packaging size remains at a premium within the passenger compartment. Moreover, the temperature regulation device generally has the minimum area needed to heat or cool the glasses, so as to reduce the cost of materials.

Suitable heaters include resistant heaters such as resistance wire heaters or positive temperature coefficient (PTC) heaters. The resistance wire heaters typically comprise one or more conductors (e.g. metal, alloy or carbon fiber) surrounded by one or more protective or insulating layers. In one preferred embodiment, the conduct comprises a plurality of metal strands braided together and covered by an insulating material.

The conductors may be attached to a substrate to facilitate holding the conductor in the desired arrangement for placement of the heater in the vehicle and/or to facilitate energy transference between the temperature regulation device and the glasses. Suitable substrates include woven and non-woven fabrics (e.g. a felt), polymeric films, foam sheets (e.g. neoprene or reticulated foam) and other materials that do not completely thermally insulate the temperature regulation device from the glasses. The substrate may also be selected to have an anti-rattle functionality. The conductors may be attached to the substrate through an adhesive, sewing or through other mechanical fasteners. In one embodiment, the conductor is sandwiched between two layers of substrate(s). In another embodiment, a web of electrically insulating but thermally conductive material is used keep the conductor in the desired arrangement for placement in the vehicle. In another embodiment, the substrate is part of the compartment in which the heater is mounted such as attached to the molded plastic cup of a dedicated glasses holder in an overhead console. In this embodiment, the substrate does not necessarily separate the heater from the glasses, (although this is an option).

For PTC heaters, conductive polymers may be printed on a substrate, such a polymeric film. As with mirror heaters, the substrate should be flexible, but need not be stretchable, as may be needed for a seat heater.

For all types of heaters, the substrate may also include an aesthetically acceptable A-surface that will not damage the glasses or its lens and/or mediate the heating capacity of the heater. Exemplary heaters of different types may also be found in U.S. Pat. Nos. 6,838,647; 6,727,467; 6,686,562; 6,150,642; 6,064,037 and U.S. Patent Publications 20050242081; 20050199611; 20040169028; 20040100131; 20040094534, all of which are hereby incorporated by reference.

TEDs may be used to provide heat to the glasses or remove heat therefrom to warm or cool the glasses. TEDs operate in a known manner by producing an active side that is warm or cool upon the application of current, with the waste side having the opposite effect. Changing the direction of the current switch thermal regulation of the active side (e.g. from warming to cooling). TEDs in the form of films or sheets may be preferred for use in this invention, such as those shown in U.S. Pat. No. 6,700,052, which is hereby incorporated by reference. Substrates may also be used with TEDs to provide a suitable A-surface and/or for mediating the temperature regulating aspects of the TED. An optionally a duct and/or fan may be utilized to exhaust the waste side of the TED. In the alternative, a secondary TED may be used to convert waste heat to electricity, which may be used to supplement the power source (discussed below).

The temperature regulation device also comprises one or more pair of electrical contacts suitable for electrically connecting the device to a power source, preferably through a wiring harness. The type of contacts utilized depends on the type of heater, ranging from weld or solder points for connection to the power source to snaps or other mechanical fasteners or plugs.

The temperature regulation device is located within the passenger compartment of the vehicle, typically within reach of the driver, so that the glasses may be conveniently stored when not in use. For example, the temperature regulation device may be part of a sun visor, located in a center console between or on the front seats of the vehicle, located in the glove box, or in an overhead console, in the door, on the dashboard, or the like. In one embodiment, the temperature regulation device is located within a compartment that has a closeable and/or latchable door (e.g. a dedicated glasses holder, such as seen in FIG. 1). The regulation device may be located on the door of the compartment or the body of the compartment.

Furthermore, for an aftermarket device, the temperature regulation device may be located anywhere within the passenger compartment, as selected by the occupant.

Because the temperature regulation device is not typically located in areas that are subject to repeated loads (e.g. seats, head rests or arm rests), materials with enhanced durability are not required, representing a cost saving on materials, manufacture and installation.

The glasses temperature controller also comprises an electrical plug to a power source. In addition making a physical connection to the power source, the electrical plug may also include a wiring harness. The electrical plug may include any suitable mechanism for making electricity available to the temperature regulation device such as a connector, a USB or a Firewire connector, a cigarette lighter (e.g. for an aftermarket device), or the like. Use of either male or female connectors may be used on the controller and/or wiring harness. The length and size of the wiring harness are desirably kept to a minimum to reduce materials costs. For example, for a temperature regulation device located in an overhead console, it preferably connects to wiring utilized for providing power to overhead lights in the vehicle. In another embodiment, the wiring harness is longer and routed under the headliner and down the pillar to a power source.

Any power source may be used, with those that include the power source for the vehicle generally (e.g. car battery or alternator) being preferred. In the alternative, the power source may be self contained (e.g. fuel cell, AA or 9 volt batteries).

The glasses temperature controller also comprises a control device that controls the supply of power to the temperature regulation device, and thereby regulates the temperature of the glasses. The control device may be incorporated into the temperature regulation device (e.g. in a PTC heater), located on the substrate along with the regulation device or as part of the wiring harness. The control device may be automatic, manual or have a combination of functionality. One example of an automatic control device would be one that turns on the temperature regulation device when the vehicle is started and turns off the temperature regulation device after a set period of time. The control device may incorporate a temperature sensor (e.g. a thermostat) such that the device turns on only when the ambient temperature is below (or above) a set temperature. Furthermore, the automatic control device may use the temperature sensor to turn off the power when a set temperature is reached.

A manual switch or rheostat may be used as the control device, leaving the control of the device to the operator of the vehicle. An auditory or visual indicator may be used in combination with the control device to indicate the operation of the temperature regulation device or the completion of the temperature regulation of the glasses. For example, a red light may indicate that the temperature regulation device is on and a green light may indicate when the glasses have reached a set temperature or when the device has been on for a set period of time.

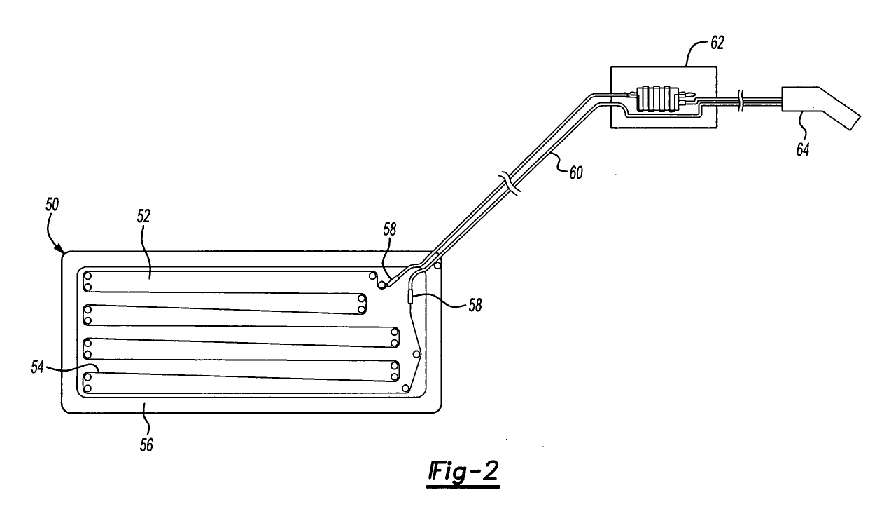

In one embodiment, as seen in FIG. 2, the temperature controller 50 comprises a heater 52 that has a resistance wire 54 laid out on and attached to a substrate 56. A pair of electrical contacts 58 serves as the connection points for a wiring harness 60 that include a thermostat 62 and an electrical plug 64. The thermostat functions as an automatic control device for the heater that turns off the heater when it reaches a set temperature. The electrical plug connects the wiring harness and heater to the power source to permit operation of the temperature controller.

In additional to the various original equipment embodiments discussed herein, aftermarket embodiment are also contemplated. In one embodiment, the glasses temperature controller is a self-contained device with it own power source, such as a battery, where the temperature controller is mounted by the occupant to the dashboard through adhesive or a clip, to the sun visor through a clip or to another convenient location in the passenger compartment. In another aftermarket embodiment, the cigarette lighter of the vehicle is used as the power source.

The present invention further comprises methods of regulating the temperature of glasses. Suitable steps include supplying power to a temperature regulation device for a set period of time or until a set temperature has been achieved, where an attachment device holds the glasses near the temperature regulation device. Another embodiment includes manually turning on power to the temperature regulation device, followed by automatically turning off power after a set period of time has elapsed or after a set temperature has been achieved.

The terms ‘sunglasses’ and ‘glasses’ are used as a convenience. It should be understood that all manner of glasses are contemplated as being used with this invention; thus, glasses that have tinted and untinted lens are contemplated as are lens with and without protective coatings (e.g. abrasion resistance, UV coating, etc. Further, glasses with prescription and nonprescription lens are also contemplated.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A temperature controller for regulating the temperature of glasses in a vehicle, comprising:
a solid state temperature regulation device comprising at least a pair of electrical contacts;
an attachment device to hold the glasses near the temperature regulation device;
an electrical plug to connect the temperature regulation device to a power source through the electrical contacts; and
a control device to regulate the temperature of the glasses.

2. The controller of claim 1 wherein the temperature regulation device comprises a resistance wire heater, a positive temperature coefficient heater or a thermoelectric device.

3. The controller of claim 2 wherein the temperature regulation device comprises a resistance wire heater located between a first substrate and a second substrate.

4. The controller of claim 2 wherein the temperature regulation device comprises a resistance wire heater mounted on a substrate, wherein the substrate separates the temperature regulation device from the glasses held by the attachment device.

5. The controller of claim 4 wherein the substrate is a foam.

6. The controller of claim 4 wherein the control device automatically powers on the temperature regulation device when the vehicle is started.

7. The controller of claim 6 wherein the control device automatically powers on the temperature regulation device when the ambient temperature of the vehicle is at set limit.

8. The controller of claim 7 wherein the control device automatically powers down the temperature regulation device when a set temperature is reached or after a set time period has elapsed.

9. The controller of claim 8 further comprising a temperature sensor that measures the temperature of the heater, the substrate, the glasses, or combinations thereof.

10. The controller of claim 4 wherein a manual control device regulates the operation of the temperature regulation device.

11. A glasses heater, comprising:
a resistance wire heater mounted on a substrate and having a-pair of electrical contacts;
an attachment device to hold a pair of glasses in the passenger compartment of vehicle and separated from the resistance wire heat by the substrate;
a wiring harness connecting a electrically connector to the pair of contacts; and
a control device connected to the resistance wire heater comprising a thermostat.

12. The glasses heater of claim 11 wherein the resistance wire heater is located with a compartment having a closeable door.

13. The glasses heater of claim 12 wherein the attachment device is located on closeable door of the compartment.

14. The glasses heater of claim 13 wherein the compartment is a dedicated glasses holder.

15. A method of regulating the temperature of glasses in a vehicle, comprising:
supplying power to a temperature regulating device located near a glasses attachment device for a set period of time or until a set temperature has been achieved, wherein the glasses attachment device is within a passenger compartment of a vehicle.

16. The method of claim 15 wherein the temperature regulating device is a resistance wire heater separated from glasses held by the attachment device by a substrate.

17. The method of claim 16 wherein the attachment device is part of a door to a compartment.

18. The method of claim 17 further comprising indicating to an occupant when the set period of time has elapsed or when the set temperature has been reached.
